(19) United States
(12) Patent Application Publication
(10) Pub. No.: US 2025/0167962 A1
(43) Pub. Date: May 22, 2025

(54) SINGLE DOWNLINK CONTROL INFORMATION BASED ACTIVATION COMMAND FOR TRANSMISSION CONFIGURATION INDICATION STATE

(71) Applicant: Nokia Technologies Oy, Espoo (FI)

(72) Inventors: Subin NARAYANAN, Oulu (FI); Sami-Jukka HAKOLA, Kempele (FI); Samuli Heikki TURTINEN, Ii (FI)

(21) Appl. No.: 18/947,962

(22) Filed: Nov. 14, 2024

Related U.S. Application Data
(60) Provisional application No. 63/599,886, filed on Nov. 16, 2023.

(51) Int. Cl. H04L 5/00; H04W 72/232

(52) U.S. Cl. CPC H04L 5/0053; H04W 72/232

(57) ABSTRACT

Example embodiments of the present disclosure generally relate to methods, devices, apparatuses and computer readable storage medium for single downlink control information (sDCI) based activation command for transmission configuration indication (TCI) state. The method comprises: receiving, by a terminal device from a network device, an activation command for a sDCI at least indicating whether a TCI state for a certain TCI codepoint indicates a first joint TCI state and whether a second joint TCI state associated with the certain TCI codepoint is present; and determining, based on the activation command, the certain TCI codepoint indicates at least one of the first joint TCI state or the second joint TCI state.

### FIELDS

Various example embodiments of the present disclosure generally relate to the field of telecommunication and in particular, to methods, devices, apparatuses and computer readable storage medium for single downlink control information (sDCI) based activation command for transmission configuration indication (TCI) state.

### BACKGROUND

For the work item “new radio (NR) multiple input multiple output (MIMO) evolution”, a host of enhancements for multi-antenna operation has been discussed. One related enhancement is unified TCI operation with multiple transmission reception points (multi-TRP).

### SUMMARY

In a first aspect of the present disclosure, there is provided an apparatus. The apparatus comprises at least one processor; and at least one memory storing instructions that, when executed by the at least one processor, cause the apparatus at least to: receive, from a network device, an activation command for a sDCI at least indicating whether a TCI state for a certain TCI codepoint indicates a first joint TCI state and whether a second joint TCI state associated with the certain TCI codepoint is present; and determine, based on the activation command, the certain TCI codepoint indicates at least one of the first joint TCI state or the second joint TCI state.

In a second aspect of the present disclosure, there is provided an apparatus. The apparatus comprises at least one processor; and at least one memory storing instructions that, when executed by the at least one processor, cause the apparatus at least to: transmit, to a terminal device, an activation command for a sDCI at least indicating whether a TCI state for a certain TCI codepoint indicates a first joint TCI state and whether a second joint TCI state associated with the certain TCI codepoint is present.

In a third aspect of the present disclosure, there is provided a method. The method comprises: receiving, by a terminal device from a network device, an activation command for a sDCI at least indicating whether a TCI state for a certain TCI codepoint indicates a first joint TCI state and whether a second joint TCI state associated with the certain TCI codepoint is present; and determining, based on the activation command, the certain TCI codepoint indicates at least one of the first joint TCI state or the second joint TCI state.

In a fourth aspect of the present disclosure, there is provided a method. The method comprises: transmitting, by a network device to a terminal device, an activation command for a sDCI at least indicating whether a TCI state for a certain TCI codepoint indicates a first joint TCI state and whether a second joint TCI state associated with the certain TCI codepoint is present.

In a fifth aspect of the present disclosure, there is provided an apparatus. The apparatus comprises means for receiving, from a network device, an activation command for a sDCI at least indicating whether a TCI state for a certain TCI codepoint indicates a first joint TCI state and whether a second joint TCI state associated with the certain TCI codepoint is present; and means for determining, based on the activation command, the certain TCI codepoint indicates at least one of the first joint TCI state or the second joint TCI state.

In a sixth aspect of the present disclosure, there is provided an apparatus. The apparatus comprises means for transmitting, to a terminal device, an activation command for a sDCI at least indicating whether a TCI state for a certain TCI codepoint indicates a first joint TCI state and whether a second joint TCI state associated with the certain TCI codepoint is present.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart illustrating an example of process according to some example embodiments of the present disclosure;

FIG. 3 illustrates an example of a message format including sDCI based activation command for TCI state according to some example embodiments of the present disclosure;

FIG. 4 illustrates a flowchart of a method implemented at a first device according to some example embodiments of the present disclosure;

FIG. 5 illustrates a flowchart of a method implemented at a second device according to some example embodiments of the present disclosure;

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “transmission reception point (TRP)” may refer to an antenna port or an antenna array (with one or more antenna elements) available to the network device located at a specific geographical location. For example, a network device may be coupled with multiple TRPs in different geographical locations to achieve better coverage. Alternatively, or in addition, multiple TRPs may be incorporated into a network device, or in other words, the network device may comprise the multiple TRPs. The term “TRP” may be also referred to as a cell, such as a macro-cell, a small cell, a pico-cell, a femto-cell, a remote radio head, a relay node, etc. It is to be understood that the term “TRP” may refer to a logical concept which may be physically implemented by various manner. For example, a TRP may refer to or correspond to a physical cell identity (PCI) or control resource set (CORESET) Pool Index (i.e., CORESETPoolIndex).

The unified TCI states may work according to three levels, namely configured, activated, and indicated. A UE may be configured up to 128 TCI states and up to 8 TCI states can be activated out of the configured TCI states. Only one TCI state (or a TCI state pair), determined by DCI indication, may be used by the UE.

Multi-TRP is an operation with two different modes, namely sDCI (i.e., one physical downlink control channel (PDCCH)/DCI schedules UE for both TRPs, with DCI codepoint being mapped to one or two different TCI states) and multi-DCI (i.e., the UE is explicitly configured with two CORESET “pools”, so each TRP can schedule UE independently using a specific CORESET pool index).

For the sDCI based multi-TRP, both TRPs in a serving cell always use the same TCI state configuration. Activating TCI states for unified TCI states have two options, namely joint (UL+DL) TCI states and separate (UL & DL) TCI states. Using those for multi-TRP means that each TRP can have 1-2 TCI states. The existing medium access control (MAC) control element (CE) for the physical downlink shared channel (PDSCH) TCI state already includes the 1-2 DL TCI states but can only possibly be extended for joint TCI states.

Some agreements on joint TCIs are listed below:
For sDCI based multi-TRP operation using unified TCI state framework, introduce the new MAC CE, with the following high level design principles:
   If the signaling type of the unified TCI state configuration is configured by RRC (i.e., either joint DL/UL TCI state or separate DL/UL TCI state), it applies to both TRPs (i.e., as configured by RRC for both TRPs).
The following information can be indicated by the MAC CE (for joint DL/UL TCI mode):
   if the unified TCI state is for one of the TRPs (i.e., 1st or 2nd) or for both TRPs,
   if the indicated TCI codepoint consists of one TCI state, whether the indicated TCI state(s) is for the first or second TRP(s)

Furthermore, the following agreements are made on the separate MAC CEs for joint and separate TCI state activations with multi-TRP, i.e., separate MAC CEs on the enhanced unified TCI state for sDCI-based multi-TRP operation are introduced for joint TCI state and separate DL/UL TCI states, respectively.

On unified TCI framework extension for sDCI-based multi-TRP operation, the following are supported:
For a serving cell configured with joint DL/UL TCI mode, a full-set or any sub-set of {first joint TCI state, second joint TCI state} can be mapped to a TCI codepoint of the existing TCI field in a DCI format 1_1/1_2 by TCI state activation command (e.g., MAC-CE).
For a serving cell configured with separate DL/UL TCI mode, a full-set or any sub-set of {first DL TCI state, first UL TCI state, second DL TCI state, second UL TCI state} can be mapped to a TCI codepoint of the existing TCI field in a DCI format 1_1/1_2 by TCI state activation command (e.g., MAC-CE).
TCI state activation command (e.g., MAC-CE) should indicate that each joint/DL/UL TCI state mapped to a TCI codepoint is the first or second joint/DL/UL TCI state.

In this situation, based on RANI agreement, MAC CE should indicate that each joint/DL/UL TCI state mapped to a TCI codepoint is the first or second joint/DL/UL TCI state. However, the RAN2 agreement states MAC CE should indicate that each joint/DL/UL TCI state mapped to a TCI codepoint is first or/and second TRP.

Because the RAN1 and RAN2 agreements on unified TCI framework extension for sDCI-based multi-TRP operation are not aligned, the enhancement of a MAC CE design may need to be further discussed.

According to some example embodiments of the present disclosure, there is provided a solution for sDCI based activation command for TCI state. In this solution, UE receives an activation command for sDCI at least indicating whether a TCI state for a certain TCI codepoint indicates a first joint TCI state and whether a second joint TCI state associated with the certain TCI codepoint is present. Based on the activation command, UE determines the certain TCI codepoint indicates the first joint TCI state and/or the second joint TCI state.

Example embodiments of the present disclosure will be described in detail below with reference to the accompanying drawings.

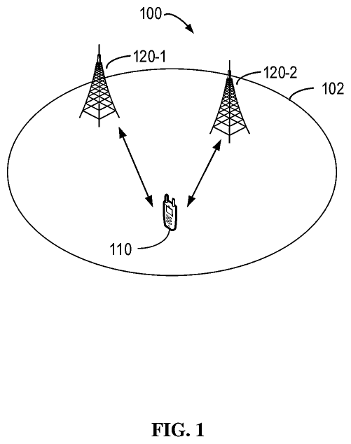

FIG. 1 shows an example communication network 100 in which embodiments of the present disclosure may be implemented. As shown in FIG. 1, the communication network 100 may include a terminal device 110 (e.g., a UE).

The communication network 100 may further a network device 120-1 and a network device 120-2. Each of the network device 120-1 and the network device 120-2 may be referred to as a gNB or a TRP. Hereinafter the network device 120-1 and the network device 120-2 may be referred to as a network device 120 collectively.

Both the network device 120-1 and the network device 120-2 may serve the terminal device 110. That is, each of the network device 120-1 and the s network device 120-2 may serve the terminal device 110 within its serving cell. In this case, the serving cell associated with the network device 120-1 and the serving cell associated with the network device 120-2 may be referred to as a special cell (SpCell) 102 of the terminal device 110. The SpCell may be referred to as a primary cell (PCell) and/or a primary secondary cell (PSCell).

In some scenario, the terminal device 110 may be configured with multi-TRPs (MTRP), for example, a first TRP (e.g., the network device 120-1) and a second TRP (e.g., the network device 120-2) within a SpCell of the terminal device 110.

When the terminal device 110 communicates with the network device 120 within a serving cell, it is to be understood that the terminal device 110 may communicate with the one of or both the first TRP and the second TRP. For example, the terminal device may be allowed to transmit and/or receive control information and data from the first TRP and the second TRP.

It is to be understood that the number of network devices and terminal devices shown in FIG. 1 is given for the purpose of illustration without suggesting any limitations. The communication network 100 may include any suitable number of network devices and terminal devices.

In some example embodiments, links from the network device 120 to the terminal device 110 may be referred to as a downlink (DL), while links from the terminal device 110 to the network device 120 may be referred to as an uplink (UL). In DL, the network device 120 is a transmitting (TX) device (or a transmitter) and the terminal device 110 is a receiving (RX) device (or receiver). In UL, the terminal device 110 is a TX device (or transmitter) and the network device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

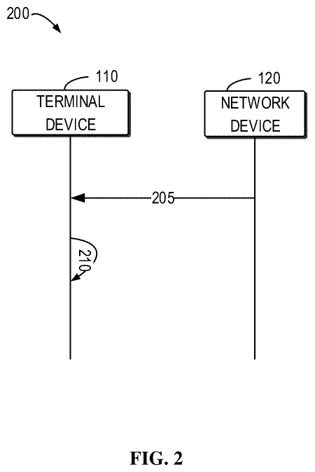

Reference is now made to FIG. 2, which shows a signaling chart 200 for communication according to some example embodiments of the present disclosure. As shown in FIG. 2, the signaling chart 200 involves the terminal device 110 and the network device 120. For the purpose of discussion, reference is made to FIG. 1 to describe the signaling chart 200.

For the multi-TRP operation, sDCI mode is supported. That is, a single DCI may schedule the terminal device 110 for both TRPs (e.g., the network device 120-1 and the network device 120-2) with a DCI codepoint being mapped to one or two different TCI states.

In this scenario, the terminal device 110 may receive (205), from the network device 120, an activation command for sDCI which at least indicates whether a TCI state for a certain TCI codepoint indicates a first joint TCI or not and whether a second joint TCI state associated with the certain TCI codepoint is present.

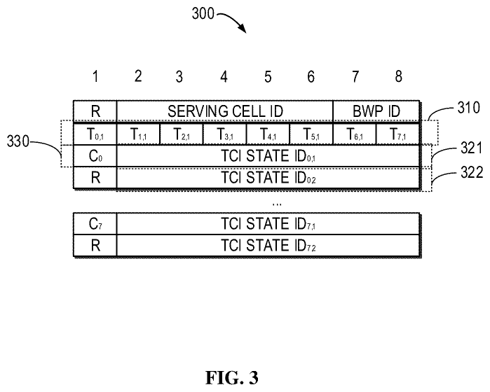

As an example, the activation command may be indicated by a MAC-CE with a specific message format. FIG. 3 illustrates an example of a message format including sDCI based activation command for TCI state according to some example embodiments of the present disclosure.

As shown in FIG. 3, an example of MAC-CE 300 for the activation command may comprise a field 310 for indicating whether a TCI state for a codepoint i indicates a first joint TCI or not, which may be denoted as “T_{i,1}”, where i is the index of the codepoint of the DCI TCI field. The field 310 may occupy up to 8 bits (i.e., T_{0,1}, T_{1,1}, T_{2,1}, T_{3,1}, T_{4,1}, T_{5,1}, T_{6,1}, T_{7,1}) and each bit may indicate whether a TCI state for each of codepoints 0-7 indicates a first joint TCI or not.

For example, the bit T_{1,1} indicating whether a TCI state for the codepoint 1 indicates the first joint TCI or not. If the value of the T_{1,1} is 1, the TCI state for the codepoint 1 indicates the first joint TCI, while if the value of the T_{1,1} is 0, the TCI state for the TCI codepoint 1 does not indicate the first joint TCI.

In the MAC-CE 300, a field “TCI state ID_{i,j}” (e.g., field 321) may indicate the TCI state identified by TCI-StateId, where i is the index of the codepoint of the DCI TCI field.

TCI state ID_{i,j} denotes the j^{th} TCI state indicated for the i^{th} codepoint in the DCI TCI field. The TCI codepoint to which the TCI States are mapped is determined by its ordinal position among all the TCI codepoints with sets of TCI state ID_{i,j} fields. For example, the first TCI codepoint with TCI state ID_{0,1} (e.g., field 321) and TCI state ID_{0,2} (e.g., field 322) may be mapped to the codepoint value 0, the second TCI codepoint with TCI state ID_{1,1} and TCI state ID_{1,2} shall be mapped to the codepoint value 1 and so on.

Furthermore, the MAC-CE 300 may comprise a field “Cᵢ” indicating whether a second joint TCI associated with a certain TCI codepoint i, i.e., the octet containing TCI state ID_{i,2} is present. For example, in field 330, the value of C₀ may indicate whether a second joint TCI associated with the codepoint 0 is present. If the value of C₀ is 1, the second joint TCI associated with the codepoint 0 is present. If the value of C₀ is 0, the second joint TCI associated with the codepoint 0 is not present. That is, the TCI state ID_{i,2} is optional based on the indication of the Cᵢ field.

As described above, based on the design of MAC-CE according to the present disclosure, the maximum number of activated TCI codepoint is 8 (e.g., codepoints 0-7) and the maximum number of TCI states (i.e., the first joint TCI state and the second joint TCI state) mapped to a TCI codepoint is 2.

As shown in FIG. 3, the MAC-CE 300 may also comprise a field “Serving Cell ID”, which indicates the identity of the Serving Cell for which the MAC CE 300 applies. The length of the field is 5 bits. If the indicated Serving Cell is configured as part of a simultaneousTCI-UpdateList1 or simultaneousTCI-UpdateList2, this MAC CE 300 applies to all the Serving Cells configured in the set simultaneousTCI-UpdateList1 or simultaneousTCI-UpdateList2, respectively.

The MAC-CE 300 may also comprise a field “BWP ID”, which indicates a DL BWP for which the MAC CE 300 applies as the codepoint of the DCI bandwidth part indicator field. The length of the BWP ID field is 2 bits.

The reserved bit “R” in the MAC-CE 300 may be set to 0.

Based on the received activation command (e.g., the MAC-CE 300), the terminal device 110 may determine (210) the certain TCI codepoint indicates at least one of the first joint TCI state or the second joint TCI state.

For example, the terminal device 110 may determine that the codepoint i indicates at least one of the first joint TCI state or the second joint TCI state based on a combination of (T_{i,1}, Cᵢ) indicated in MAC-CE 300. As described above, T_{i,1} indicates whether the (joint) TCI state for codepoint i indicates the first joint TCI state (by T_{i,1}=1) or not (by T_{i,1}=0) and Cᵢ indicates whether a second joint TCI associated with the codepoint i is present.

For example, for codepoint i, corresponding full-set or any sub-set of first or second joint TCI states of the combination of (T_{i,1}, Cᵢ) are list as below:

If (T_{i,1}, Cᵢ)=(1, 1), the (joint) TCI state for codepoint i indicates the first joint TCI state and the second joint TCI associated with the codepoint i is present. In this case, the terminal device 110 determines that the codepoint i indicates both first and second joint TCI states are present.

If (T_{i,1}, Cᵢ)=(1, 0), the (joint) TCI state for codepoint i indicates the first joint TCI state and the second joint TCI associated with the codepoint i is not present. In this case, the terminal device 110 determines that the codepoint i indicates only the first joint TCI state is present.

If (T_{i,1}, Cᵢ)=(0, 1), the (joint) TCI state for codepoint i does not indicate the first joint TCI state and the second joint TCI associated with the codepoint i is present. In this case, the terminal device 110 determines that the codepoint i indicates that only the second joint TCI state is present.

If (T_{i,1}, Cᵢ)=(0, 0), the (joint) TCI state for codepoint i does not indicate the first joint TCI state and the second joint TCI associated with the codepoint i is not present. In this case, the terminal device 110 determines that there is no TCI state.

After determining the configuration of TCI state(s), the terminal device 110 may monitor the corresponding reference signal accordingly.

According to the design of sDCI based (Joint TCI state) activation command (e.g., MAC-CE) for multiple TRP operation, the signal overhead may be reduced.

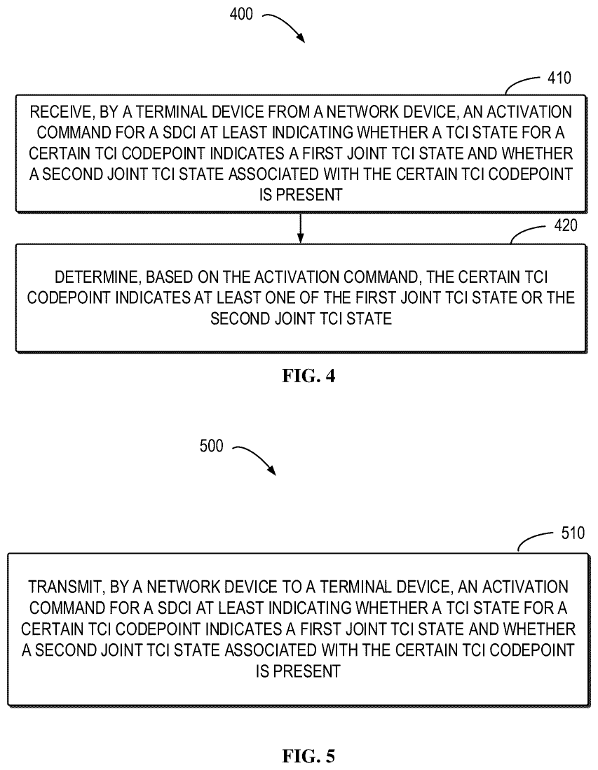

FIG. 4 shows a flowchart of an example method 400 implemented at a first device in accordance with some example embodiments of the present disclosure. For the purpose of discussion, the method 400 will be described from the perspective of the terminal device 110 in FIG. 1.

At block 410, the terminal device 110 receives, from a network device, an activation command for a sDCI at least indicating whether a TCI state for a certain TCI codepoint indicates a first joint TCI state and whether a second joint TCI state associated with the certain TCI codepoint is present.

At block 420, the terminal device 110 determines, based on the activation command, the certain TCI codepoint indicates at least one of the first joint TCI state or the second joint TCI state.

In some example embodiments, the method 400 further comprises: in accordance with a determination that the joint TCI state for the certain TCI codepoint indicates the first joint TCI state and the second joint TCI state associated with the certain TCI codepoint is not present, determining that the certain TCI codepoint indicates only the first joint TCI state.

In some example embodiments, the method 400 further comprises: in accordance with a determination that the joint TCI state for the certain TCI codepoint indicates the first joint TCI state and the second joint TCI state associated with the certain TCI codepoint is present, determining that the certain TCI codepoint indicates both the first joint TCI state and the second joint TCI state.

In some example embodiments, the method 400 further comprises: in accordance with a determination that the joint TCI state for the certain TCI codepoint does not indicate the first joint TCI state and the second joint TCI state associated with the certain TCI codepoint is present, determining that the certain TCI codepoint indicates the second joint TCI state.

In some example embodiments, the method 400 further comprises: in accordance with a determination that the joint TCI state for the certain TCI codepoint does not indicate the first joint TCI state and the second joint TCI state associated with the certain TCI codepoint is not present, determining that there is no joint TCI state.

In some example embodiments, the activation command further indicates at least one of: an identifier of the first joint TCI state indicated for the certain TCI codepoint in DCI TCI field, or an identifier of the second joint TCI state indicated for the certain TCI codepoint in DCI TCI field if a second joint TCI state associated with the certain TCI codepoint is present.

In some example embodiments, the activation command is indicated by a medium access control, MAC, control element, CE.

FIG. 5 shows a flowchart of an example method 500 implemented at a second device in accordance with some example embodiments of the present disclosure. For the purpose of discussion, the method 500 will be described from the perspective of the network device 120 in FIG. 1.

At block 510, the network device 120 transmits, to a terminal device, an activation command for a sDCI at least indicating whether a TCI state for a certain TCI codepoint indicates a first joint TCI state and whether a second joint TCI state associated with the certain TCI codepoint is present.

In some example embodiments, the activation command further indicates at least one of: an identifier of the first joint TCI state indicated for the certain TCI codepoint in DCI TCI field, or an identifier of the second joint TCI state indicated for the certain TCI codepoint in DCI TCI field if a second joint TCI state associated with the certain TCI codepoint is present.

In some example embodiments, the activation command is indicated by a medium access control, MAC, control element, CE.

In some example embodiments, an apparatus capable of performing any of the method 400 (for example, the terminal device 110 in FIG. 1) may comprise means for performing the respective operations of the method 400. The means may be implemented in any suitable form. For example, the means may be implemented in a circuitry or software module. The apparatus may be implemented as or included in the terminal device 110 in FIG. 1.

In some example embodiments, the apparatus comprises means for receiving, from a network device, an activation command for a sDCI at least indicating whether a TCI state for a certain TCI codepoint indicates a first joint TCI state and whether a second joint TCI state associated with the certain TCI codepoint is present; and means for determining, based on the activation command, the certain TCI codepoint indicates at least one of the first joint TCI state or the second joint TCI state.

In some example embodiments, the apparatus further comprises: means for, in accordance with a determination that the joint TCI state for the certain TCI codepoint indicates the first joint TCI state and the second joint TCI state associated with the certain TCI codepoint is not present, determining that the certain TCI codepoint indicates only the first joint TCI state.

In some example embodiments, the apparatus further comprises: means for, in accordance with a determination that the joint TCI state for the certain TCI codepoint indicates the first joint TCI state and the second joint TCI state associated with the certain TCI codepoint is present, determining that the certain TCI codepoint indicates both the first joint TCI state and the second joint TCI state.

In some example embodiments, the apparatus further comprises: means for, in accordance with a determination that the joint TCI state for the certain TCI codepoint does not indicate the first joint TCI state and the second joint TCI state associated with the certain TCI codepoint is present, determining that the certain TCI codepoint indicates the second joint TCI state.

In some example embodiments, the apparatus further comprises: means for in accordance with a determination that the joint TCI state for the certain TCI codepoint does not indicate the first joint TCI state and the second joint TCI state associated with the certain TCI codepoint is not present, determining that there is no joint TCI state.

In some example embodiments, the activation command further indicates at least one of: an identifier of the first joint TCI state indicated for the certain TCI codepoint in DCI TCI field, or an identifier of the second joint TCI state indicated for the certain TCI codepoint in DCI TCI field if a second joint TCI state associated with the certain TCI codepoint is present.

In some example embodiments, the activation command is indicated by a MAC CE.

In some example embodiments, the apparatus further comprises means for performing other operations in some example embodiments of the method 400 or the terminal device 110. In some example embodiments, the means comprises at least one processor; and at least one memory storing instructions that, when executed by the at least one processor, cause the performance of the apparatus.

In some example embodiments, an apparatus capable of performing any of the method 500 (for example, the network device 120 in FIG. 1) may comprise means for performing the respective operations of the method 500. The means may be implemented in any suitable form. For example, the means may be implemented in a circuitry or software module. The apparatus may be implemented as or included in the network device 120 in FIG. 1.

In some example embodiments, the apparatus comprises means for transmitting, to a terminal device, an activation command for a sDCI at least indicating whether a TCI state for a certain TCI codepoint indicates a first joint TCI state and whether a second joint TCI state associated with the certain TCI codepoint is present.

In some example embodiments, the activation command further indicates at least one of: an identifier of the first joint TCI state indicated for the certain TCI codepoint in DCI TCI field, or an identifier of the second joint TCI state indicated for the certain TCI codepoint in DCI TCI field if a second joint TCI state associated with the certain TCI codepoint is present.

In some example embodiments, the activation command is indicated by a medium access control, MAC, control element, CE.

In some example embodiments, the apparatus further comprises means for performing other operations in some example embodiments of the method 500 or the network device 120. In some example embodiments, the means comprises at least one processor; and at least one memory storing instructions that, when executed by the at least one processor, cause the performance of the apparatus.

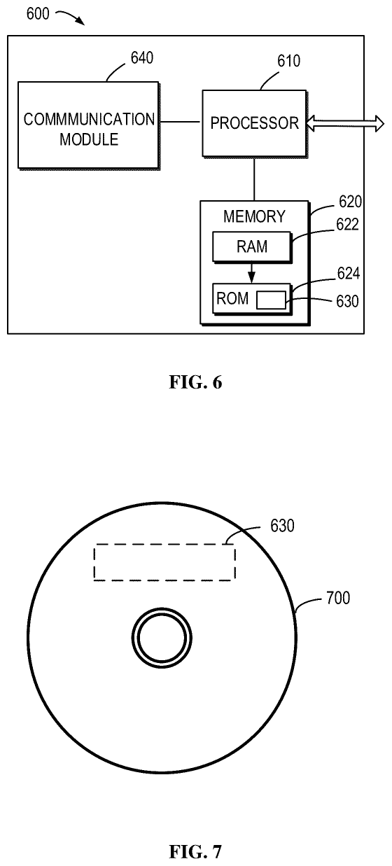

FIG. 6 is a simplified block diagram of a device 600 that is suitable for implementing example embodiments of the present disclosure. The device 600 may be provided to implement a communication device, for example, the terminal device 110 or the network device 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-23. (canceled)

24. An apparatus comprising:
at least one processor; and
at least one memory storing instructions that, when executed by the at least one processor, cause the apparatus at least to:
receive, from a network device, an activation command for a transmission configuration indication (TCI) codepoint, the TCI codepoint indicating whether a TCI state for a certain TCI codepoint indicates a first joint TCI state and whether a second joint TCI state associated with the certain TCI codepoint is present; and
determine, based on the activation command, that a joint TCI state of the certain TCI codepoint indicates at least one of the first joint TCI state and the second joint TCI state.

25. The apparatus of claim 24, wherein the apparatus is caused to:
in accordance with a determination that the joint TCI state for the certain TCI codepoint indicates the first joint TCI state and the second joint TCI state associated with the certain TCI codepoint are not present, determine that the certain TCI codepoint indicates only the first joint TCI state.

26. The apparatus of claim 24, wherein the apparatus is caused to:
in accordance with a determination that the joint TCI state for the certain TCI codepoint indicates the first joint TCI state and the second joint TCI state associated with the certain TCI codepoint are present, determine that the certain TCI codepoint indicates both the first joint TCI state and the second joint TCI state.

27. The apparatus of claim 24, wherein the apparatus is caused to:
in accordance with a determination that the joint TCI state for the certain TCI codepoint does not indicate the first joint TCI state and the second joint TCI state associated with the certain TCI codepoint are present, determine that the certain TCI codepoint indicates the second joint TCI state.

28. The apparatus of claim 24, wherein the apparatus is caused to:
in accordance with a determination that the joint TCI state for the certain TCI codepoint does not indicate the first joint TCI state and the second joint TCI state associated with the certain TCI codepoint are not present, determine that there is no joint TCI state.

29. The apparatus of claim 24, wherein the activation command further indicates the following:
an identifier of the first joint TCI state indicated for the certain TCI codepoint in DCI TCI field; and
an identifier of the second joint TCI state indicated for the certain TCI codepoint in DCI TCI field if a second joint TCI state associated with the certain TCI codepoint is present.

30. The apparatus of claim 29, wherein the activation command is indicated by a medium access control (MAC) control element (CE).

31. A system comprising:
an apparatus;
at least one processor; and
at least one memory storing instructions that, when executed by the at least one processor, cause the apparatus at least to:
receive, from a network device, an activation command for a transmission configuration indication (TCI) codepoint, the TCI codepoint indicating whether a TCI state for a certain TCI codepoint indicates a first joint TCI state and whether a second joint TCI state associated with the certain TCI codepoint is present; and
determine, based on the activation command, that a joint TCI state of the certain TCI codepoint indicates at least one of the first joint TCI state and the second joint TCI state.

32. The system of claim 31, wherein the apparatus is caused to:
in accordance with a determination that the joint TCI state for the certain TCI codepoint indicates the first joint TCI state and the second joint TCI state associated with the certain TCI codepoint are not present, determine that the certain TCI codepoint indicates only the first joint TCI state.

33. The system of claim 31, wherein the apparatus is caused to:
in accordance with a determination that the joint TCI state for the certain TCI codepoint indicates the first joint TCI state and the second joint TCI state associated with the certain TCI codepoint are present, determine that the certain TCI codepoint indicates both the first joint TCI state and the second joint TCI state.

34. The system of claim 31, wherein the apparatus is caused to:
in accordance with a determination that the joint TCI state for the certain TCI codepoint does not indicate the first joint TCI state and the second joint TCI state associated with the certain TCI codepoint are present, determine that the certain TCI codepoint indicates the second joint TCI state.

35. The system of claim 31, wherein the apparatus is caused to:
in accordance with a determination that the joint TCI state for the certain TCI codepoint does not indicate the first joint TCI state and the second joint TCI state associated with the certain TCI codepoint are not present, determine that there is no joint TCI state.

36. The system of claim 31, wherein the activation command further indicates the following:
an identifier of the first joint TCI state indicated for the certain TCI codepoint in DCI TCI field; and
an identifier of the second joint TCI state indicated for the certain TCI codepoint in DCI TCI field if a second joint TCI state associated with the certain TCI codepoint is present.

37. The system of claim 36, wherein the activation command is indicated by a medium access control (MAC) control element (CE).

38. A method comprising:
receiving, from a network device, an activation command for a transmission configuration indication (TCI) codepoint, the TCI codepoint indicating whether a TCI state for a certain TCI codepoint indicates a first joint TCI state and whether a second joint TCI state associated with the certain TCI codepoint is present; and
determining, based on the activation command, that a joint TCI state of the certain TCI codepoint indicates at least one of the first joint TCI state and the second joint TCI state.

39. The method of claim 38, further comprising:
in accordance with a determination that the joint TCI state for the certain TCI codepoint indicates the first joint TCI state and the second joint TCI state associated with the certain TCI codepoint are not present, determining that the certain TCI codepoint indicates only the first joint TCI state.

40. The method of claim 38, further comprising:
in accordance with a determination that the joint TCI state for the certain TCI codepoint indicates the first joint TCI state and the second joint TCI state associated with the certain TCI codepoint are present, determining that the certain TCI codepoint indicates both the first joint TCI state and the second joint TCI state.

41. The method of claim 38, further comprising:
in accordance with a determination that the joint TCI state for the certain TCI codepoint does not indicate the first joint TCI state and the second joint TCI state associated with the certain TCI codepoint are present, determining that the certain TCI codepoint indicates the second joint TCI state.

42. The method of claim 38, further comprising:
in accordance with a determination that the joint TCI state for the certain TCI codepoint does not indicate the first joint TCI state and the second joint TCI state associated with the certain TCI codepoint are not present, determining that there is no joint TCI state.

43. The method of claim 38, wherein the activation command further indicates the following:
an identifier of the first joint TCI state indicated for the certain TCI codepoint in DCI TCI field; and
an identifier of the second joint TCI state indicated for the certain TCI codepoint in DCI TCI field if a second joint TCI state associated with the certain TCI codepoint is present.
